(19) United States
(12) Patent Application Publication
(10) Pub. No.: US 2022/0154515 A1
(43) Pub. Date: May 19, 2022

(54) ACTUATOR AND CABLE-OPERATED DRIVE MECHANISM FOR CLOSURE PANEL

(71) Applicant: Magna Closures Inc., Newmarket (CA)

(72) Inventors: Michael BAYLEY, Newmarket (CA); Steven LIU, Newmarket (CA)

(21) Appl. No.: 17/439,531

(22) PCT Filed: Apr. 14, 2020
(86) PCT No.: PCT/CA2020/050496

§ 371 Date: Sep. 15, 2021

Related U.S. Application Data
(60) Provisional application No. 62/834,828, filed on Apr. 16, 2019.

(51) Int. Cl. E05F 15/646

(52) U.S. Cl. CPC E05F 15/646; E05Y 2201/668; E05Y 2201/664; E05Y 2900/531; E05Y 2201/654; E05Y 2201/672

(57) ABSTRACT

A cable-operated drive mechanism for a vehicle sliding closure panel includes a housing and a motor configured to selectively rotate an output shaft. A cable drum is supported in the housing for rotation in response to rotation of the output shaft. A first cable coupled to the cable drum extends through a first cable port for operable attachment to the vehicle sliding closure panel. An adjuster pulley in the housing is moveable between assembly and installed positions. A second cable coupled to the cable drum engages the adjuster pulley and extends, in non-reversed bending fashion, through a second cable port for operable attachment to the vehicle sliding closure panel. The second cable has an assembly free-length when the adjuster pulley is in the assembly position and an installed free-length when the adjuster pulley is in the installed position, with the installed free-length being less than the assembly free-length.

### CROSS-REFERENCE TO RELATED APPLICATION

This application claims the benefit of U.S. Provisional Application Ser. No. 62/834,828, filed Apr. 16, 2019, which is incorporated herein by reference in its entirety.

### FIELD

The present disclosure relates generally to motor vehicle closure panels, and more particularly to motor vehicle sliding closure panels and cable-operated actuation mechanisms therefor.

### BACKGROUND

This section provides background information related to the present disclosure which is not necessarily prior art.

In many motor vehicles, sliding door assemblies are configured for sliding movement between open and closed positions via actuation of a motor operably coupled to a cable actuation mechanism. The cable actuation mechanism typically includes a pair of cables having first ends coupled to a driven cable drum and second ends operably coupled to the sliding door, with a midsection of the cables, extending between the first and second ends, meandering about a plurality of intermediate idler pulleys over reverse, generally S-shaped bends, thereby changing directions between positive and negative angles relative to a common axis. At least some of the idler pulleys are typically located on opposites sides of the cable drum from one another, wherein the idler pulleys are commonly spring biased to take up slack in the cables.

In the above sliding door assemblies, and in other known sliding door assemblies, the assembled free length of the cables can become longer than optimally desired in use, thereby introducing uncertainty and complicating the function of the sliding door assembly during use. As such, over time, the functionality of the sliding door can be compromised, thereby resulting in the need to service the sliding door. The increased free length of the cables is generally introduced during and to facilitate assembly, to facilitate routing the cables about their respective pulleys; however, as discussed above, if the increased free length is allowed to remain after assembly, the functionality of the sliding door can be less than optimal.

The reverse bends introduced into the cables via meandering of the cables back-and-forth about the plurality of idler pulleys reduces the fatigue life of the cables. The fatigue life is reduced due to the cable being repeatedly routed over the reversed positive and negative angles during use, causing opposite sides of the cable to undergo both tension and a compression forces, similar to that of bending a paperclip or piece of wire back and forth to cause work hardening of the wire, which ultimately causes the wire to break. To increase cable life, the cable side that experiences tension should not be subjected to compression and the side of the cable that experiences compression should not be subjected to tension as a result of engaging a pulley, or the amount of tension a compressible cable side experiences should be minimized and the amount of compression a tensioned cable side experiences should be minimized, for example when pulleys axis are inclined with one another, as described herein below in more detail.

In addition to the fatigue issues discussed above, having pulleys located on opposite sides of the driven cable drum can increase the size and weight of the cable actuation mechanism, which can ultimately have an impact on design freedom and fuel economy.

In view of the above, there is a need to provide cable actuation mechanisms for motor vehicle sliding door assemblies that facilitate ease of assembly, that are efficient in operation, while at the same time being compact, robust, durable, lightweight and economical in manufacture, assembly, and exhibiting a long and useful life.

### SUMMARY

This section provides a general summary of the disclosure and is not intended to be a comprehensive listing of all features, advantages, aspects and objectives associated with the inventive concepts described and illustrated in the detailed description provided herein.

It is an object of the present disclosure to provide cable-operated drive mechanisms for a motor vehicle sliding door assemblies that address at least some of those issues discussed above with known cable-operated drive mechanisms.

In accordance with the above object, it is an aspect of the present disclosure to provide a cable-operated drive mechanism for a motor vehicle sliding door assembly that facilitates ease of assembly of the sliding door assembly to a body of the motor vehicle, that is efficient in operation, while at the same time being compact, robust, durable, lightweight and economical in manufacture, assembly, and in use.

In accordance with another aspect of the disclosure, the present disclosure is directed to a motor vehicle sliding closure panel having a cable-operated drive mechanism constructed in accordance with one or more aspects of the disclosure.

In accordance with the above aspects, a cable-operated drive mechanism for a motor vehicle sliding closure panel includes a housing having a first cable port and a second cable port and a motor configured to be selectively energized to rotate an output shaft in opposite directions. A cable drum is supported in the housing for rotation in opposite first and second directions about a drum axis in response to rotation of the output shaft. A first cable is coupled to the cable drum and extends away from the cable drum through the first cable port to a first end configured for operable attachment to the motor vehicle sliding closure panel. The first cable winds about the cable drum in response to the cable drum rotating in the first direction and unwinds from the cable drum in response to the cable drum rotating in the second direction. A second cable is coupled to the cable drum and extends away from the cable drum to a second end configured for operable attachment to the motor vehicle sliding closure panel. The second cable winds about the cable drum in response to the cable drum rotating in the second direction and unwinds from the cable drum in response to the cable drum rotating in the first direction. An adjuster pulley is disposed in the housing, wherein the adjuster pulley is moveable between a released assembly position and a fixed installed position. The second cable engages the adjuster pulley and extends therefrom, in non-reversed bending fashion, through the second cable port. The second cable has an assembly free-length extending outwardly from the second cable port when the adjuster pulley is in the released assembly position and an installed free-length extending outwardly from the second cable port when the adjuster pulley is in the fixed installed position, with the installed free-length being less than the assembly free-length.

In accordance with another aspect of the disclosure, the cable-operated drive mechanism can further include an adjuster axle extending between opposite end regions, with the adjuster pulley being disposed on the adjuster axle between the opposite end regions. The opposite end regions can be disposed in a pair of channels for selective translation along the pair of channels to move the adjuster pulley between the released assembly position and the fixed installed position.

In accordance with another aspect of the disclosure, the cable-operated drive mechanism can further include a locking feature configured to releasably fix the adjuster axle against translation in the pair of channels to releasably lock the adjuster pulley in the fixed installed position. The locking feature can further be selectively manipulated to allow the adjuster axle to translate freely in the slot to allow the adjuster pulley to be moved from the fixed installed position to the released assembly position, such as may be desired while servicing the motor vehicle sliding closure panel.

In accordance with another aspect of the disclosure, the locking feature can include at least one plug configured for receipt in at least one of the pair of channels to prevent translation of the adjuster axle in the pair of channels upon locating the adjuster pulley in the fixed installed position.

In accordance with another aspect of the disclosure, each of the pair of channels can include an arcuate end region forming the locking feature, such that upon translating the adjuster axle into the arcuate end regions, the adjuster pulley is releasably maintained in the fixed installed position.

In accordance with another aspect of the disclosure, the cable-operated drive mechanism can further include a pair of pulleys disposed in the housing, with the second cable extending from the cable drum and engaging a first one of the pair of pulleys and then extending to and engaging the adjuster pulley and then extending to and engaging a second one of the pair of pulleys, and then extending outwardly from the housing through the second cable port.

In accordance with another aspect of the disclosure, the pair of pulleys can be configured to rotate about a common axis, thereby facilitating the minimization of components and reducing the overall size of the cable-operated drive mechanism.

In accordance with another aspect of the disclosure, the pair of pulleys can be configured to rotate in side-by-side relation with one another, with each of the pair of pulleys rotating in a separate plane, with the planes being generally parallel with one another.

In accordance with another aspect of the disclosure, the pair of pulleys can be configured to rotate about different axes, thereby avoiding contact of the second cable routed thereabout with itself.

In accordance with another aspect of the disclosure, the different axes about which the pair of pulleys rotate can be configured in inclined relation with one another.

In accordance with another aspect of the disclosure, the different axes about which the pair of pulleys rotate can intersect one another in oblique relation with one another.

In accordance with another aspect of the disclosure, the first cable port and the second cable port can be aligned in substantially coaxial relation with one another, thereby allowing the profile height of the cable-operated drive mechanism to be minimized.

In accordance with another aspect of the disclosure, the adjuster pulley can be provided as the only pulley in the housing other than the cable drum, thereby minimizing the number of components and allowing the size and weight of the cable-operated drive mechanism to be minimized.

In accordance with another aspect of the disclosure, the first cable port and the second cable port can be axially misaligned with one another, thereby allowing the length of the cable-operated drive mechanism to be minimized.

In accordance with another aspect of the disclosure, a method of constructing a cable-operated drive mechanism for a motor vehicle sliding closure panel is provided. The method includes a step of providing a housing having a first cable port and a second cable port and a step of disposing a motor having an output shaft in the housing and configuring the output shaft to rotate in opposite directions upon selectively energizing the motor. Further, supporting a cable drum in the housing for rotation in opposite first and second directions about a drum axis in response to rotation of the output shaft. Further yet, coupling a first cable to the cable drum and extending a first end of the first cable through the first cable port for operable attachment to the motor vehicle sliding closure panel. Further, coupling a second cable to the cable drum and extending a second end of the second cable through the second cable port for operable attachment to the motor vehicle sliding closure panel. A further step includes disposing an adjuster pulley in the housing and configuring the adjuster pulley for selective movement between a released assembly position and a fixed installed position. Further yet, entraining the second cable into engagement with the adjuster pulley such that the second cable has an assembly free length extending outwardly from the second cable port when the adjuster pulley is selectively moved into the released assembly position to facilitate assembly of the motor vehicle sliding closure panel, and an installed free length extending outwardly from the second cable port when the adjuster pulley is selectively moved to the fixed installed position to complete assembly, with the installed free length being less than the assembly free length.

In accordance with a further aspect of the disclosure, the method can further include a step of disposing opposite end regions of an adjuster axle, supporting the adjuster pulley, in a pair of channels for translation of the adjuster pulley between the released assembly position and the fixed installed position and disposing a locking feature in at least one of the pair of channels to releasably fix the adjuster axle against translation in the pair of channels to releasably lock the adjuster pulley in the fixed installed position.

In accordance with a further aspect of the disclosure, the method can further include a step of disposing opposite end regions of an adjuster axle, supporting the adjuster pulley, in a pair of channels for translation of the adjuster pulley between the released assembly position and the fixed installed position and forming each of the pair of channels having an arcuate end region forming a locking feature to releasably maintain the adjuster pulley in the fixed installed position.

In accordance with a further aspect of the disclosure, the method can further include a step of disposing a pair of pulleys in the housing and extending the second cable from the cable drum into engagement with a first one of the pair of pulleys, then into engagement with the adjuster pulley, and then into engagement with a second one of the pair of pulleys and then through the second cable port.

Further areas of applicability will become apparent from the description provided herein. The description and specific examples in this summary are only intended to illustrate certain non-limiting embodiments which are not intended to limit the scope of the present disclosure.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 illustrates a motor vehicle with a sliding door assembly having a sliding door drive assembly including a cable-operated drive mechanism in accordance with an aspect of the disclosure, with the sliding door assembly shown in a closed state;

FIG. 1A is a view similar to FIG. 1 with the sliding door assembly shown in an open state;

FIG. 1B is a fragmentary, perspective view of an interior portion of the motor vehicle and sliding door assembly of FIGS. 1 and 1A;

FIG. 2 is a schematic illustration of a cable assembly extending outwardly from a housing of the cable-operated drive mechanism of the sliding door assembly of FIGS. 1 and 1A with the cable assembly being routed about pulleys configured to be fixed to a quarter panel or other support structure of the motor vehicle and being operably coupled to a slide member fixed to the motor vehicle sliding door in accordance with one aspect of the disclosure;

FIG. 2A is a perspective view of a portion of the sliding door drive assembly of the sliding door assembly of FIGS. 1-1B;

FIG. 3 is a side elevation view illustrating a cable-operated drive mechanism constructed in accordance with one aspect of the disclosure;

FIGS. 4-4B are side elevation views illustrating an adjuster pulley of the cable-operated drive mechanism of FIG. 3 being moved from a released assembly position in FIG. 4 to a fixed installed position in FIG. 4A and being releasably fixed in the fixed installed position by a locking feature in FIG. 4B;

FIGS. 5 and 5A are side elevation views illustrating a portion of a cable-operated drive mechanism constructed in accordance with another aspect of the disclosure with an adjuster pulley of the cable-operated drive mechanism being moved from a released assembly position in FIG. 5 to a releasably fixed installed position in FIG. 5A;

FIG. 6 is a perspective view illustrating a portion of a cable-operated drive mechanism constructed in accordance with another aspect of the disclosure with an adjuster pulley of the cable-operated drive mechanism shown in a releasably fixed installed position;

FIG. 7 is a cross-sectional elevation view taken through an axis of rotation of a dual pulley assembly of the cable-operated drive mechanism of FIG. 6;

FIGS. 8 and 8A are side elevation views illustrating a portion of a cable-operated drive mechanism constructed in accordance with another aspect of the disclosure;

FIGS. 9 and 9A are side elevation views illustrating a portion of a cable-operated drive mechanism constructed in accordance with another aspect of the disclosure; and

FIGS. 10A and 10B is a flow diagram of a method of constructing cable-operated drive mechanism for a motor vehicle sliding closure panel in accordance with another aspect of the disclosure.

### DETAILED DESCRIPTION OF EXAMPLE EMBODIMENTS

An example embodiment of a motor vehicle sliding closure panel and cable-operated drive mechanism therefor will now be described more fully with reference to the accompanying drawings. To this end, the example embodiments of a cable-operated drive mechanism are provided so that this disclosure will be thorough, and will fully convey its intended scope to those who are skilled in the art. Accordingly, numerous specific details are set forth such as examples of specific components, devices, and methods, to provide a thorough understanding of a particular embodiment of the present disclosure. However, it will be apparent to those skilled in the art that specific details need not be employed, that the example embodiments may be embodied in many different forms, and that the example embodiments should not be construed to limit the scope of the present disclosure. In some parts of the example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

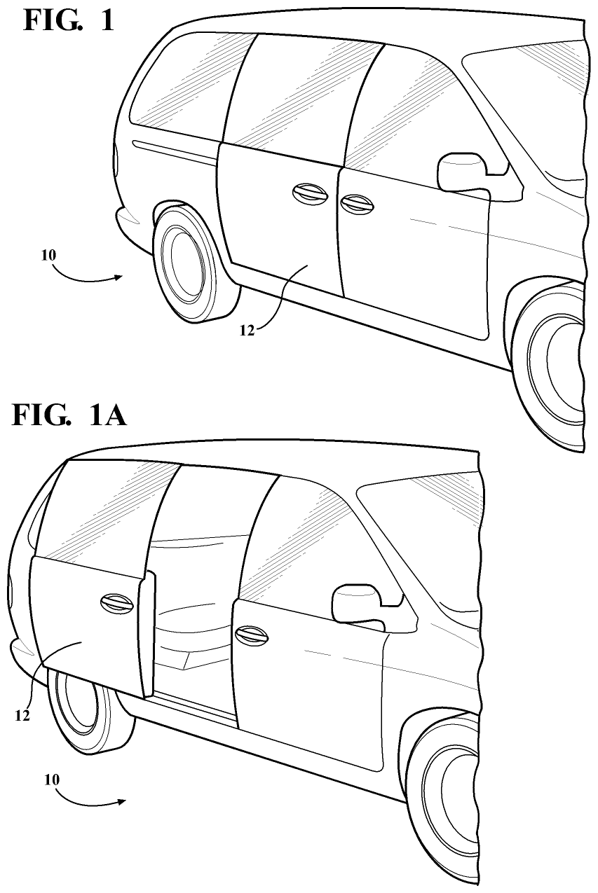

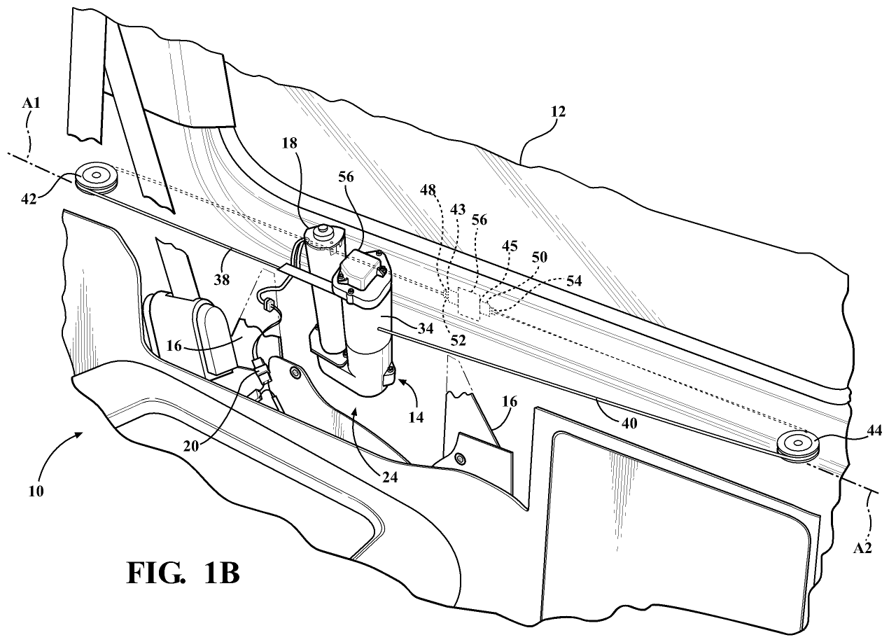

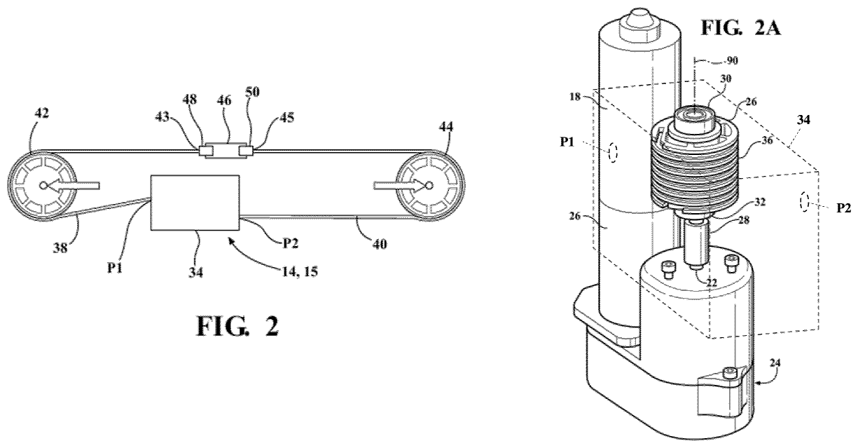

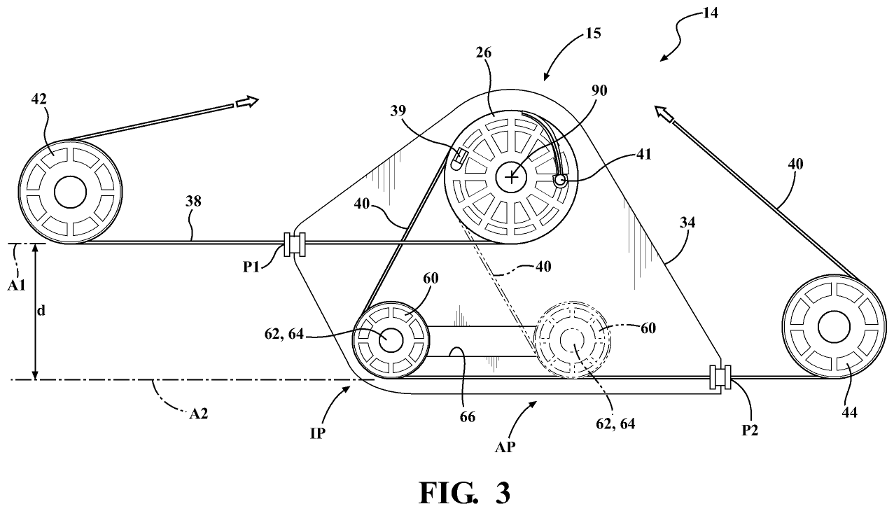

Reference is made to FIGS. 1-1B, which show a portion of a motor vehicle 10 including a sliding closure panel assembly, shown, by way of example and without limitation as a sliding door 12, having a sliding door drive assembly, generally shown at 14 (FIG. 1B), including a cable-operated drive mechanism 15 (FIG. 3) constructed in accordance with an aspect of the disclosure. The sliding door drive assembly 14 is mounted to the motor vehicle 10, such as via mounting brackets 16 to a quarter panel thereof, by way of example and without limitation, and is operatively connected to the sliding door 12 for selective (intended hereafter to mean intentionally actuated or intentionally moved) movement between a closed state (FIG. 1) and an open state (FIG. 1A). The sliding door drive assembly 14 includes a motor 18 that is electrically connected to an electric energy source, schematically represented by an electrical connector 20. It is contemplated that the motor 18 can use electric energy that is provided from a source known to be commonly provided in a motor vehicle, including a vehicle battery or from a generator, by way of example and without limitation. The motor 18 is preferably bidirectional, allowing for direct, selectively actuated rotation of an output shaft 22 (FIG. 2A) in opposite rotational directions. The output shaft 22 is shown as the output shaft of a gearbox, such as a planetary transmission/clutch assembly 24, by way of example and without limitation.

The cable-operated drive mechanism of sliding door drive assembly 14 includes a cable drum 26, wherein the cable drum 26 is shown coupled to the transmission/clutch assembly 24 via a coupling 28, by way of example and without limitation. The cable drum 26 is shown supported for rotation about a drum axis 90 by two sets of bearings 30, 32 that are fixedly secured to a cable drum housing 34 (FIG. 3). The cable drum 26 includes a helical groove 36 about which a cable assembly, including a first cable 38 and a second cable 40 are wound. The first cable 38 and second cable 40, by way of example and without limitation, are wound about the cable drum 26 in the helical groove 36 in opposite directions. Referring to FIG. 1, the first cable 38 has an end fixed within a first receptacle 39 of cable drum 26 and extends in generally tangent relation from the cable drum 26 through a first cable port P1 forward along the direction of a first axis A1 about a front pulley 42 whereafter the first cable 48 is redirected back toward and into coupled relation with the sliding door 12. In an embodiment, first cable 38 engages with cable drum and extends directly towards first cable port P1 without engagement of any intervening pulley(s). The second cable 40 has an end fixed within a second receptacle 41 of cable drum 26 and extends in generally tangent relation from the cable drum 26 through a second cable port P2 rearward in the direction of a second longitudinal axis A2 about a rear pulley 44 whereafter the second cable 40 is redirected back toward and into coupled relation with the sliding door 12. The first 38 cable and second cable 40 each have respective ends 43, 45 fixedly secured to a center hinge, also referred to as mount or slide member 46, which is fixedly secured to the sliding door 12. Rotation of the cable drum 26 winds one of the first cable 38 and second cable 40 and, at the same time, unwinds the other of the first cable 38 and second cable 40. Accordingly, first cable 38 is configured to wind about the cable drum 26 in response to the cable drum 26 rotating in a first direction and to unwind from the cable drum 26 in response to the cable drum rotating in an opposite second direction and, second cable 40 is configured to wind about the cable drum 26 in response to the cable drum 26 rotating in the second direction and to unwind from the cable drum 26 in response to the cable drum 26 rotating in the first direction.

The slide member 46 includes a forward cable terminal 48 and a rearward cable terminal 50 for securing the respective ends 43, 45 of first cable 38 and second cable 40 thereto. The forward cable terminal 48 and rearward cable terminal 50 can include a respective forward and rearward cable tensioners 52, 54.

Referring to FIG. 1B, a position sensor, generally indicated at 56, can be mounted to the cable drum housing 34 for indicating the rotational position of the cable drum 26. The position sensor 56 is a very high resolution position sensor and can be provided including a sensor that senses the orientation of a magnet (not shown), which is fixedly secured to the cable drum 26 for rotation therewith, as will be understood by one possessing ordinary skill in the art.

Referring to FIG. 3, the cable-operated drive mechanism has an adjuster pulley 60 disposed in the cable drum housing 34. The adjuster pulley 60 is selectively moveable between a released assembly position (AP), whereat assembly of the sliding door 12 to the motor vehicle 10 is facilitated, and a fixed installed position (IP). The second cable 40 extends in generally tangential relation from cable drum 26 and wraps about and/or engages at least a portion of adjuster pulley 60 and extends in generally tangential relation from adjuster pulley 60, in non-reversed bending fashion, through the second cable port P2. The non-reverse bending can be provided by the second cable 40 bending solely within two quadrants out of four quadrants defined by perpendicular axes of a two-dimensional Cartesian system, thereby minimizing bending stress on the second cable 40. Accordingly, if the second cable 40 extends coaxially along one of the two axes of a two-dimensional Cartesian system, it only bends and extends into only two quadrants on one side of the axis along which it extends, while not bending and extending into the opposite two quadrants. By not extending beyond the axis into the opposite two quadrants, the bending stress experienced by the second cable 40 is reduced, thereby extending the useful life of the cable 40, and in turn, reducing the potential for having to service the cable-operated drive mechanism 15.

The second cable 40 has an assembly free-length extending outwardly from the second cable port P2 when the adjuster pulley 60 is in the released assembly position AP and an installed free-length extending outwardly from the second cable port P2 when the adjuster pulley 60 is in the fixed installed position IP. It is to be recognized that the assembly free-length and the installed free-length correspond to the respective lengths of the second cable 40 that extend outwardly of the second cable port P2, wherein the installed free-length is less than the assembly free-length. As such, with the assembly free-length being relatively increased to the installed free-length, the increased length of the second cable 40 extending outwardly from the second cable port P2 makes routing of the first and second cables 38, 40 about the respective front and rear pulleys 38, 40 relatively easy. Then, after routing the first and second cables 38, 40 about the respective front and rear pulleys 38, 40, wherein the sliding door 12 is essentially installed to the motor vehicle 10, the adjuster pulley 60 can be selectively moved from the assembly position AP to the installed position IP, whereat the free-length of the second cable 40 is reduced to bring the first and second cables 38, 40 into taught, tensioned relation about the front and rear pulleys 42, 44, thereby assuring accurate, smooth sliding movement of the sliding door 12 in use. Of course, it is to be recognized, as noted above, the adjuster pulley 60 can be selectively returned to the assembly position AP, such as may be desired during service.

An adjuster axle 62 is provided to extend between opposite end regions 64, with the adjuster pulley 60 being disposed on the adjuster axle 62 between the opposite end regions 64. The opposite end regions 64 are configured to be disposed in a pair of channels 66 for sliding movement within the channels 66, thereby providing for translation of the adjuster pulley 60 between the released assembly position AP and the fixed installed position IP. The channels 66 can be formed directly in the material of the cable drum housing 34, or otherwise, the channels 66 can be formed of a separate piece of material and subsequently attached to the cable drum housing 34. In the embodiment depicted in FIG. 3, the channels 66 are formed as being straight or substantially straight (meaning the channels 66 could be less than perfectly straight), though, as discussed in an alternate embodiment hereafter, the channels can be formed otherwise.

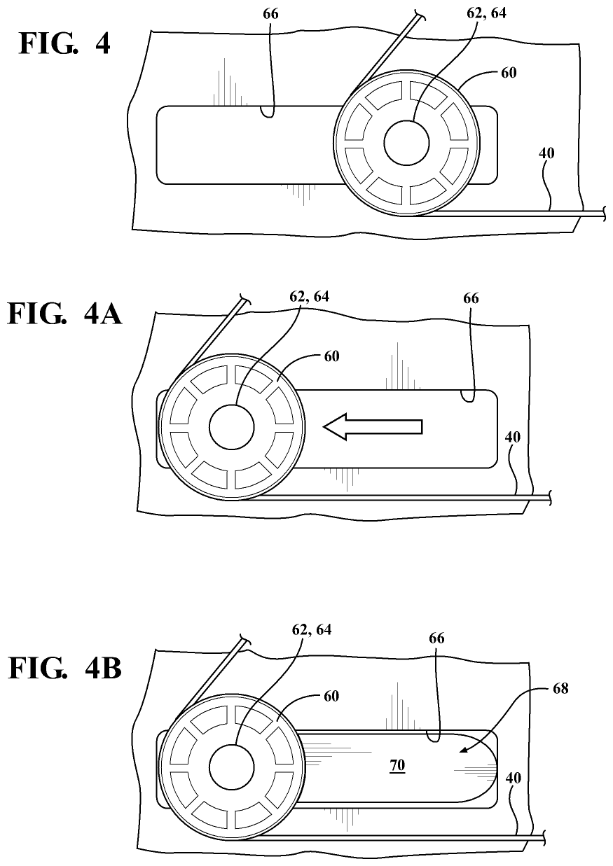

To facilitate releasably maintaining the adjuster pulley 60 in the fixed installed position, a locking feature 68 is provided and configured to releasably fix the adjuster axle 62 against translation in the pair of channels 66 upon translating the adjuster axle 62 to the fixed installed position, thereby releasably locking the adjuster pulley 60 in the fixed installed position. The locking feature 68 is shown (FIG. 4B), by way of example and without limitation, as including at least one elongate plug 70. The at least one plug 70 is configured for receipt in at least one of the pair of channels 66 to prevent translation of the adjuster axle 62 in the pair of channels 66. The plug or pair of plugs 70 are shaped for close receipt within the channels 66, such that the plugs 70 fill or substantially the region of the channels 66 not occupied by the adjuster axle 62, thereby fixing the adjuster axle 62 against translation in the channels 66, and thus, placing the adjuster pulley 60 in the fixed installed position IP. Of course, when desired, such as during service, the plug(s) 70 can be removed to allow the adjuster axle 62 and adjuster pulley 60 to be moved from the fixed installed position IP to the assembly position AP, thereby reestablishing the increased assembly free-length to allow the first and second cables 38, 40 to be released from the front and rear pulleys 42, 44.

The first longitudinal axis A1 and the second longitudinal axis A2, as shown in FIG. 3, extend in generally parallel relation with one another, by way of example and without limitation, in laterally spaced relation from one another by a predefined distance (d). The offset distance d of the axes A1, A2 allows the single adjuster pulley 60 configuration (sole pulley in the housing 34, aside from cable drum 26) by avoiding contact and interference of the first and cables 38, 40 with one another, while also allowing the length (L) of cable drum housing 34 to be minimized.

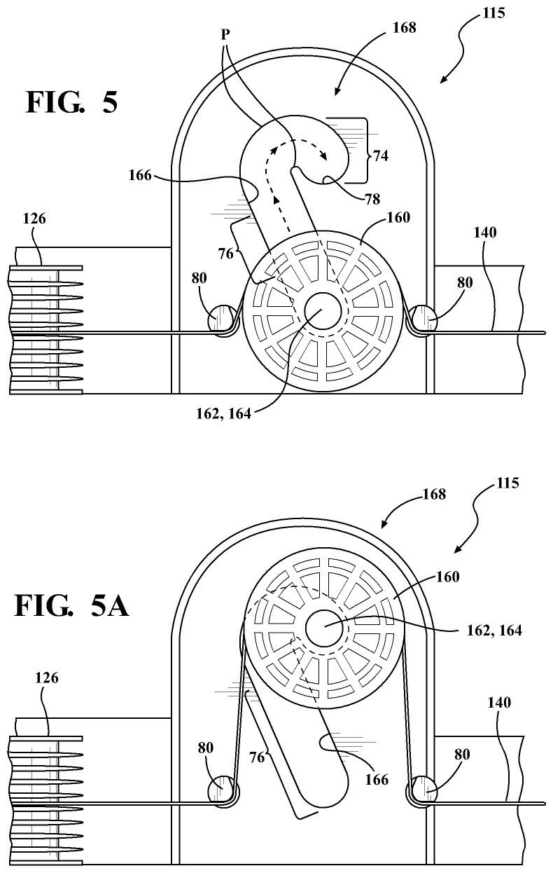

Referring now to FIGS. 5 and 5A, in accordance with another aspect of the disclosure, wherein the same references numerals as used above, offset by a factor of 100, are used to identify like features, rather than the channel 66 extending along a generally straight path, a channel 166 of a cable-operated drive mechanism 115 constructed in accordance with another aspect of the disclosure can have an arcuate region, shown as an arcuate, generally C-shaped end region 74, with the arcuate end region 74 being used to provide an integral locking feature 168. As such, the opposite end regions 164 of adjuster axle 162 can be slid from a lower, generally straight region 76 of the channel 166 from the assembly position AP of the adjuster pulley 160 (FIG. 5) upwardly along the generally straight region 76 and guided about the arcuate end region 74 to translate the adjuster pulley 160 to the releasably fixed installed position IP (FIG. 5A). The adjuster pulley 160 is releasably maintained in the installed position IP during normal use, as intended, via a predetermined tension imparted within the second cable 140 during assembly. As such, as the adjuster pulley 160 is translated from the assembly position AP to the releasably installed position IP, the second cable 140 extending from cable drum 126 is placed under a predetermined amount of tension, such than upon traversing a peak (P) of the arcuate region 74, the adjuster axle 162 and adjuster pulley 160 are pulled in elastic, spring-like fashion under the imparted tension to an end 78 of the arcuate region, whereat the second cable 140 remains under sufficient tension to prevent inadvertent, unintentional movement of the adjuster axle 162 away from the end 78 and to prevent movement of the adjuster pulley 160 away from the releasably installed position IP. Accordingly, only during intentional application of a suitable force, such as by a person during service, is the adjuster pulley 160 able to be selectively moved from the installed position IP back to the assembly position AP. Upon moving the adjuster pulley 160 to the releasably installed position IP, the second cable 162 can be brought into engagement with low sliding friction guide members 80, such as smooth bearing grade surface members, e.g. pins or roller members, by way of example and without limitation, to facilitate imparting the predetermined tension into the second cable 140 and maintaining the second cable 140 in accurately guided position along the adjuster pulley 160. It is to be recognized that the guide members 80 can be formed as an integral, monolithic piece of material with cable drum housing 134, or provided as separate members therefrom and assembly thereto, as desired for the intended application.

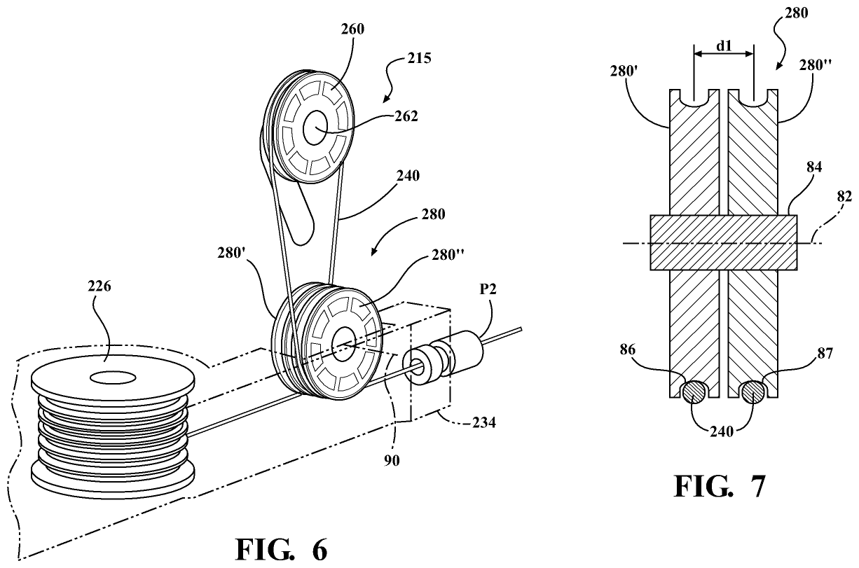

Referring now to FIGS. 6 and 7, in accordance with another aspect of the disclosure, wherein the same references numerals as used above, offset by a factor of 200, are used to identify like features, guide members 280 of a cable-operated drive mechanism 215 constructed in accordance with another aspect of the disclosure can be provided as a pair of pulleys 280′, 280″. The pair of pulleys 280′, 280″, in accordance with one exemplary aspect of the disclosure, are illustrated as being disposed in the housing 234 such that a second cable 240 extends from a cable drum 226 and engages a first one of the pair of pulleys 280′, shown as wrapping about a portion of first pulley 280′, and thereafter, the second cable 240 extends to and engages an adjuster pulley 260 disposed on an adjuster axle 262, as described for adjuster pulley 160 and adjuster axle 162, shown as wrapping about a portion of adjuster pulley 260, and then second cable 240 extends back toward and engages a second one of the pair of pulleys 280″, and thereafter, the second cable 240 extends directly from the second pulley 280″ outwardly from the housing through a second cable port P2. As best shown in FIG. 7, the pair of pulleys 280′, 280″ are disposed in side-by-side relation with one another and are configured to rotate about a common axis 82. The pulleys 280′, 280″ can be disposed on a single, common axle 84, or it is contemplated that they could be disposed on separate, coaxial axles, if desired. In this configuration, it will be appreciated that the second cable 240 is maintain out of engagement with itself due to its being offset from itself by a distance (d1) extending between grooves 86, 87 of the pulleys 280′, 280″.

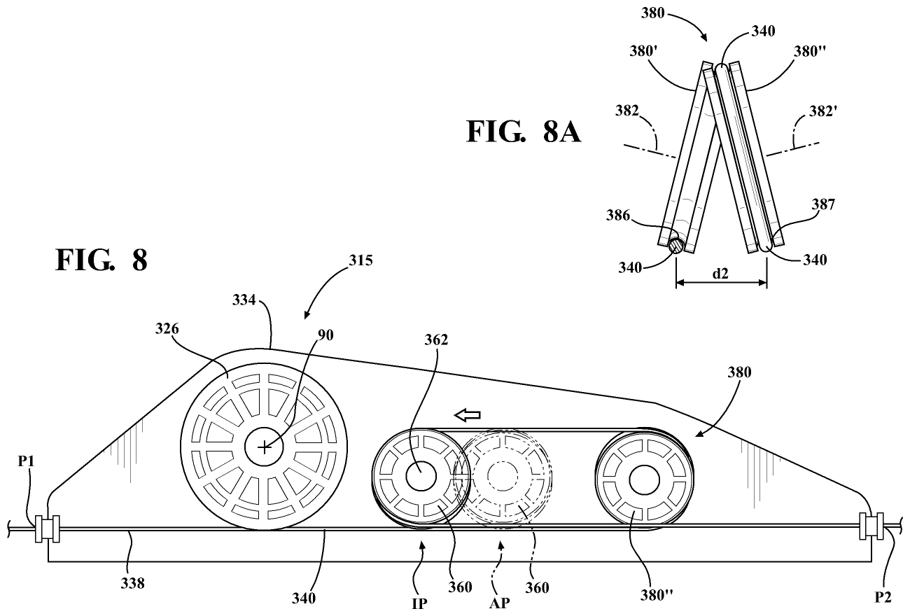

Referring now to FIG. 8, in accordance with another aspect of the disclosure, wherein the same references numerals as used above, offset by a factor of 300, are used to identify like features, guide members 380 of a cable-operated drive mechanism 315 constructed in accordance with another aspect of the disclosure can be provided as a pair of pulleys 380′, 380″; however, rather than rotating about a common axis, as discussed above for pulleys 280′, 280″, the pulleys 380′, 380″ rotate about different axes 382, 382′. Referring to FIG. 6, 8, 9, there is provided a cable operated mechanism having an adjuster pulley adjuster pulley 360 provided as one of the pair of pair of pulleys 380′, 380″ and a single fixed pulley, such as pulley 280″, 380″, 480, provided as the other of the pair of pulleys 380′, 380″. Other numbers of pulleys may be provided. The rotational axes 382, 382′ of the pair of pulleys 380′, 380″, in accordance with another exemplary aspect of the disclosure, are illustrated as being in non-parallel, misaligned relation with one another. The pulleys 380′, 380″ are shown disposed in the housing 334 such that a second cable 340 extends from a cable drum 326 and engages a first one of the pair of pulleys 380′, shown as wrapping about a bottom portion of first pulley 380′. Thereafter, the second cable 340 wraps upwardly (as viewed in the FIGS.) and about an upper portion of one or both pulleys 380′, 380″ and then extends to and engages an adjuster pulley 360. The adjuster pulley 360 is shown disposed in generally aligned relation between cable drum 326 and adjuster pulleys 380′, 380″, and thus, second cable 340 and a first cable 338 are able to be coaxial or substantially coaxial with one another as they extend through a first cable port P1 and a second cable port P2. Accordingly, first cable port P1 and second cable port P2 can be coaxially or substantially coaxially aligned with one another, thereby allowing the height of the housing to be minimized, which in turns can contribute to weight reduction of the cable-operated drive mechanism 315. Then, second cable 340 extends from adjuster pulley 360 back toward and engages a second one of the pair of pulleys 380″, and thereafter, the second cable 340 extends directly from the second pulley 380″ outwardly from the housing through second cable port P2. As best shown in FIG. 8A, the pair of pulleys 380′, 380″ are disposed in side-by-side relation with one another in inclined relation with one another. As such, the pulleys 380′, 380″ are disposed on separate axles from one another. In this configuration, it will be appreciated that the second cable 340 is maintain out of engagement with itself due to its being offset from itself by a distance (d2) extending between grooves 386, 387 of the pulleys 380′, 380″. It will be appreciated that adjuster pulley 360 can be translated from an assembly position AP to a releasably installed position IP by translating an adjuster axle 362 along slots (not shown) as discussed above for adjuster pulley 60, and further that adjuster axle 362 can be releasably fixed in the installed position IP via any suitable locking feature (not shown), such as a plug or arcuate slot, as discussed herein.

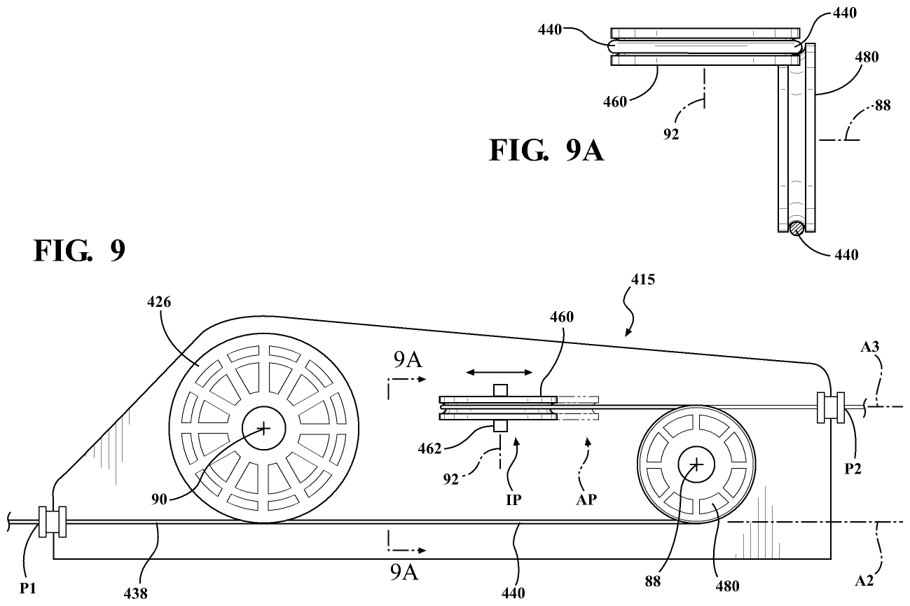

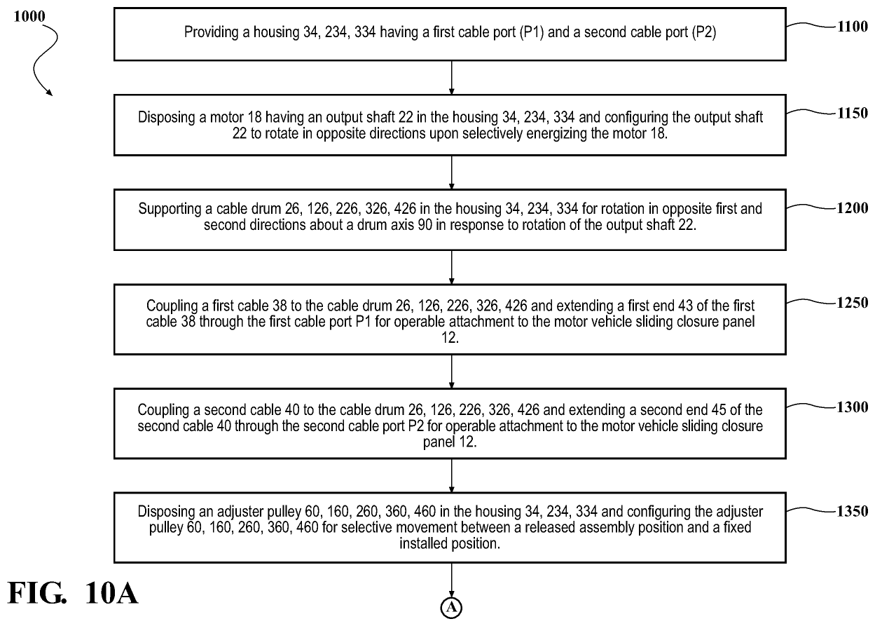

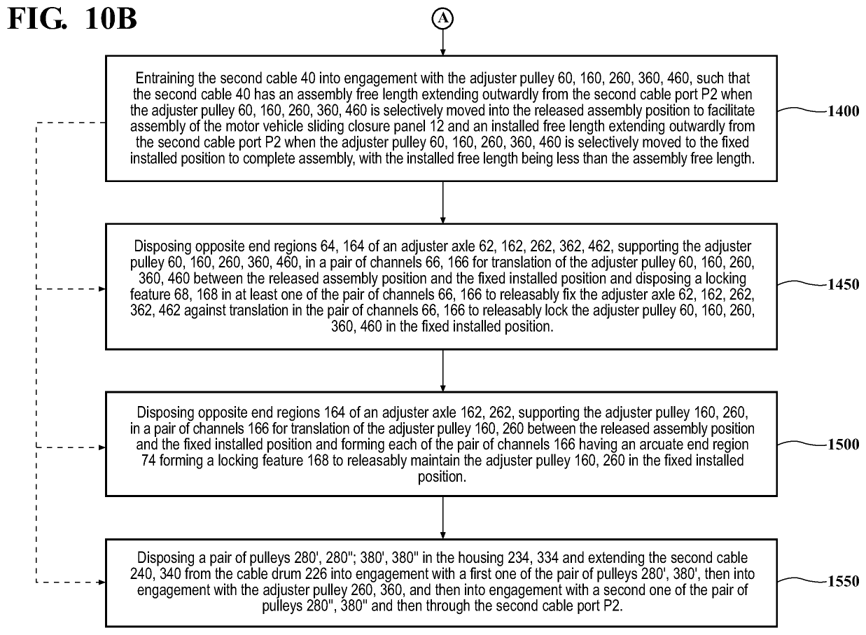

Referring now to FIGS. 9 and 9A, in accordance with another aspect of the disclosure, wherein the same references numerals as used above, offset by a factor of 400, are used to identify like features, an adjuster pulley 460 and a single idler pulley 480 of a cable-operated drive mechanism 415 constructed in accordance with another aspect of the disclosure are located on a common side of a cable drum 426. The arrangement of the adjuster pulley 460 and idler pulley 480 allow a housing (not shown) of the cable-operated drive mechanism 415 to be reduced in height, as discussed above for cable-operated drive mechanism 315; however, first and second cable ports P1, P2, through which a first cable 438 and a second cable 440 extend, respectively, are misaligned with one another. The first and second cables 438, 440 are shown as being axially aligned with one another as they extend from cable drum 426; however, second cable 440 moves out from alignment with first cable 438 as second cable 440 engages and wraps about a portion of idler pulley 480. Upon wrapping about idler pulley 480, second cable 440 extends back toward cable drum 426 in generally parallel relation with itself and with first cable 438, by way of example and without limitation. Then, second cable engages and wraps about a portion of adjuster pulley 460, where after, second cable 440 extend back away from cable drum 426 in generally parallel relation with itself and with first cable 438, by way of example and without limitation, through second cable port P2. As illustrated, idler pulley 480 rotate about an idler axis 88 that is parallel to a drum axis 90 about which cable drum 426 rotates, while adjuster pulley 460 rotates about an adjuster axis 92 that is perpendicular or substantially perpendicular to idler and drum axes 88, 90. As such, it can be seen that second cable 440 remains solely within first and second quadrants of a four quadrant Cartesian coordinate system, whether viewed relative to an axis A2 along which second cable 440 extends immediately from cable drum 426, or relative to an axis A3 along which second cable 440 extends between idler pulley 480 and adjuster pulley 460. Accordingly, second cable 440 is kept from being routed over a “reverse bend,” thereby being subjected to a reduced bending stress relative to a cable being routed over a reverse bend. It will be appreciated that the adjuster pulley 460 can be translated from an assembly position AP to a releasably installed position IP by translating an adjuster axle 462 along slots (not shown) as discussed above for adjuster pulley 60, and further that adjuster axle 462 can be releasably fixed in the installed position IP via any suitable locking feature (not shown), such as a plug or otherwise.

The adjuster pulley 460 is shown disposed in generally aligned relation between cable drum 426 and adjuster pulley 460, and thus, the height of the housing can be minimized, as discussed above. Further, it can be seen that with adjuster pulley 460 being generally orthogonal to idler pulley 480, the first cable port P1 and second cable port P2 are offset from one another.

In accordance with another aspect of the disclosure, a method 1000 of constructing a cable-operated drive mechanism 15, 115, 215, 315, 415 for a motor vehicle sliding closure panel 12 is provided. The method 1000 includes a step 1100 of providing a housing 34, 234, 334 having a first cable port (P1) and a second cable port (P2) and a step 1150 of disposing a motor 18 having an output shaft 22 in the housing 34, 234, 334 and configuring the output shaft 22 to rotate in opposite directions upon selectively energizing the motor 18. A further step 1200 includes supporting a cable drum 26, 126, 226, 326, 426 in the housing 34, 234, 334 for rotation in opposite first and second directions about a drum axis 90 in response to rotation of the output shaft 22. A further step 1250 includes coupling a first cable 38 to the cable drum 26, 126, 226, 326, 426 and extending a first end 43 of the first cable 38 through the first cable port P1 for operable attachment to the motor vehicle sliding closure panel 12. A further step 1300 includes coupling a second cable 40 to the cable drum 26, 126, 226, 326, 426 and extending a second end 45 of the second cable 40 through the second cable port P2 for operable attachment to the motor vehicle sliding closure panel 12. A further step 1350 includes disposing an adjuster pulley 60, 160, 260, 360, 460 in the housing 34, 234, 334 and configuring the adjuster pulley 60, 160, 260, 360, 460 for selective movement between a released assembly position and a fixed installed position. A further step 1400 includes entraining the second cable 40 into engagement with the adjuster pulley 60, 160, 260, 360, 460, such that the second cable 40 has an assembly free length extending outwardly from the second cable port P2 when the adjuster pulley 60, 160, 260, 360, 460 is selectively moved into the released assembly position to facilitate assembly of the motor vehicle sliding closure panel 12 and an installed free length extending outwardly from the second cable port P2 when the adjuster pulley 60, 160, 260, 360, 460 is selectively moved to the fixed installed position to complete assembly, with the installed free length being less than the assembly free length.

In accordance with a further aspect of the disclosure, the method 1000 can further include a step 1450 of disposing opposite end regions 64, 164 of an adjuster axle 62, 162, 262, 362, 462, supporting the adjuster pulley 60, 160, 260, 360, 460, in a pair of channels 66, 166 for translation of the adjuster pulley 60, 160, 260, 360, 460 between the released assembly position and the fixed installed position and disposing a locking feature 68, 168 in at least one of the pair of channels 66, 166 to releasably fix the adjuster axle 62, 162, 262, 362, 462 against translation in the pair of channels 66, 166 to releasably lock the adjuster pulley 60, 160, 260, 360, 460 in the fixed installed position.

In accordance with a further aspect of the disclosure, the method 1000 can further include a step 1500 of disposing opposite end regions 164 of an adjuster axle 162, 262, supporting the adjuster pulley 160, 260, in a pair of channels 166 for translation of the adjuster pulley 160, 260 between the released assembly position and the fixed installed position and forming each of the pair of channels 166 having an arcuate end region 74 forming a locking feature 168 to releasably maintain the adjuster pulley 160, 260 in the fixed installed position.

In accordance with a further aspect of the disclosure, the method 1000 can further include a step 1550 of disposing a pair of pulleys 280′, 280″; 380′, 380″ in the housing 234, 334 and extending the second cable 240, 340 from the cable drum 226 into engagement with a first one of the pair of pulleys 280′, 380′, then into engagement with the adjuster pulley 260, 360, and then into engagement with a second one of the pair of pulleys 280″, 380″ and then through the second cable port P2.

While the above description constitutes a plurality of embodiments of the present invention, it will be appreciated that the present invention is susceptible to further modification and change without departing from the fair meaning of the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cable-operated drive mechanism for a motor vehicle sliding closure panel, comprising:
a housing having a first cable port and a second cable port;
a motor having an output shaft, said motor being configured to be selectively energized to rotate said output shaft in opposite directions;
a cable drum supported in said housing for rotation in opposite first and second directions about a drum axis in response to rotation of said output shaft;
a first cable coupled to said cable drum and extending away from said cable drum through said first cable port to a first end configured for operable attachment to the motor vehicle sliding closure panel, said first cable being configured to wind about said cable drum in response to said cable drum rotating in said first direction and to unwind from said cable drum in response to said cable drum rotating in said second direction;
a second cable coupled to said cable drum and extending away from said cable drum through said second cable port to a second end configured for operable attachment to the motor vehicle sliding closure panel, said second cable being configured to wind about said cable drum in response to said cable drum rotating in said second direction and to unwind from said cable drum in response to said cable drum rotating in said first direction; and
an adjuster pulley disposed in said housing, said adjuster pulley being moveable between a released assembly position and a fixed installed position, said second cable engaging said adjuster pulley, wherein said second cable has an assembly free length extending outwardly from said second cable port when said adjuster pulley is in said released assembly position and an installed free length extending outwardly from said second cable port when said adjuster pulley is in said fixed installed position, said installed free length being less than said assembly free length.

2. The cable-operated drive mechanism of claim 1, further including an adjuster axle extending between opposite end regions, said adjuster pulley being disposed on said adjuster axle between said opposite end regions, said opposite end regions being disposed in a pair of channels for translation of said adjuster pulley between said released assembly position and said fixed installed position.

3. The cable-operated drive mechanism of claim 2, further including a locking feature configured to releasably fix said adjuster axle against translation in said pair of channels to releasably lock said adjuster pulley in said fixed installed position.

4. The cable-operated drive mechanism of claim 3, wherein said locking feature includes at least one plug, said at least one plug being configured for receipt in at least one of said pair of channels to prevent translation of said adjuster axle in said pair of channels.

5. The cable-operated drive mechanism of claim 3, wherein each of said pair of channels includes an arcuate end region forming said locking feature.

6. The cable-operated drive mechanism of claim 2, further including a pair of pulleys disposed in said housing, said second cable extending from said cable drum and engaging a first one of said pair of pulleys and then extending to and engaging said adjuster pulley and then extending to and engaging a second one of said pair of pulleys and then extending outwardly from said housing through said second cable port.

7. The cable-operated drive mechanism of claim 6, wherein said pair of pulleys rotate about a common axis.

8. The cable-operated drive mechanism of claim 6, wherein said pair of pulleys rotate about different axes that are inclined relative to one another.

9. The cable-operated drive mechanism of claim 1, wherein said adjuster pulley is the only pulley in said housing other than said cable drum.

10. The cable-operated drive mechanism of claim 1, wherein the second cable extends from said adjuster pulley in non-reversed bending fashion through said second cable port, wherein the second cable includes a first side undergoing a compression when engaged with the adjuster pulley, and an opposite side undergoing a tension when engaged with the adjuster pulley.

11. A cable-operated drive mechanism for a motor vehicle sliding closure panel, comprising:
a housing having a first cable port and a second cable port;
a motor having an output shaft, said motor being configured to be selectively energized to rotate said output shaft in opposite directions;
a cable drum supported in said housing for rotation in opposite first and second directions about a drum axis in response to rotation of said output shaft;
a first cable coupled to said cable drum and extending away from said cable drum through said first cable port to a first end configured for operable attachment to the motor vehicle sliding closure panel, said first cable being configured to wind about said cable drum in response to said cable drum rotating in said first direction and to unwind from said cable drum in response to said cable drum rotating in said second direction;
a second cable coupled to said cable drum and extending away from said cable drum to a second end configured for operable attachment to the motor vehicle sliding closure panel, said second cable being configured to wind about said cable drum in response to said cable drum rotating in said second direction and to unwind from said cable drum in response to said cable drum rotating in said first direction; and
at least one pulley disposed in said housing, said second cable engaging said at least one pulley and said cable drum in non-reversed bending fashion and extending from said at least one pulley through said second cable port.

12. The cable-operated drive mechanism of claim 11, wherein said at least one pulley includes a pair of pulleys disposed in said housing, said second cable extending from said cable drum and engaging a first one of said pair of pulleys and then extending to and engaging an adjuster pulley and then extending to and engaging a second one of said pair of pulleys and then extending outwardly from said housing through said second cable port.

13. The cable-operated drive mechanism of claim 12, said adjuster pulley is moveable between a released assembly position and a fixed installed position, wherein said second cable has an assembly free length extending outwardly from said second cable port when said adjuster pulley is in said released assembly position and an installed free length extending outwardly from said second cable port when said adjuster pulley is in said fixed installed position, said installed free length being less than said assembly free length.

14. The cable-operated drive mechanism of claim 12, wherein said pair of pulleys rotate about a common axis.

15. The cable-operated drive mechanism of claim 12, wherein said pair of pulleys rotate about different axes.

16. The cable-operated drive mechanism of claim 15, wherein said pair of pulleys are arranged in laterally spaced, side-by-side relation with one another.

17. A method of constructing a cable-operated drive mechanism for a motor vehicle sliding closure panel, comprising:
providing a housing having a first cable port and a second cable port;
disposing a motor having an output shaft in the housing and configuring the output shaft to rotate in opposite directions upon selectively energizing the motor;
supporting a cable drum in the housing for rotation in opposite first and second directions about a drum axis in response to rotation of the output shaft;
coupling a first cable to the cable drum and extending a first end of the first cable through the first cable port for operable attachment to the motor vehicle sliding closure panel;
coupling a second cable to the cable drum and extending a second end of the second cable through the second cable port for operable attachment to the motor vehicle sliding closure panel;
disposing an adjuster pulley in the housing and configuring the adjuster pulley for selective movement between a released assembly position and a fixed installed position; and
entraining the second cable into engagement with the adjuster pulley, such that the second cable has an assembly free length extending outwardly from the second cable port when the adjuster pulley is selectively moved into the released assembly position to facilitate assembly of the motor vehicle sliding closure panel and an installed free length extending outwardly from the second cable port when the adjuster pulley is selectively moved to the fixed installed position to complete assembly, with the installed free length being less than the assembly free length.

18. The method of claim 17, further including further including disposing opposite end regions of an adjuster axle supporting the adjuster pulley in a pair of channels for translation of the adjuster pulley between the released assembly position and the fixed installed position and disposing a locking feature in at least one of the pair of channels to releasably fix the adjuster axle against translation in the pair of channels to releasably lock the adjuster pulley in the fixed installed position.

19. The method of claim 17, further including further including disposing opposite end regions of an adjuster axle supporting the adjuster pulley in a pair of channels for translation of the adjuster pulley between the released assembly position and the fixed installed position and forming each of the pair of channels having an arcuate end region forming a locking feature to releasably maintain the adjuster pulley in the fixed installed position.

20. The method of claim 17, further including disposing a pair of pulleys in the housing and extending the second cable from the cable drum into engagement with a first one of the pair of pulleys, then into engagement with the adjuster pulley, and then into engagement with a second one of the pair of pulleys and then through the second cable port.
